(19) United States
(12) Patent Application Publication
(10) Pub. No.: US 2026/0136258 A1
(43) Pub. Date: May 14, 2026

(54) METHOD AND APPARATUS FOR PERFORMING RACH-LESS HANDOVER IN MOBILE WIRELESS COMMUNICATION SYSTEM

(71) Applicant: SETLAB Co., LTD., Gyeonggi-do (KR)

(72) Inventor: Soenghun KIM, Gyeonggi-do (KR)

(21) Appl. No.: 19/328,374

(22) Filed: Sep. 15, 2025

(30) Foreign Application Priority Data
Nov. 11, 2024 (KR) 1020240159712
Aug. 27, 2025 (KR) 1020250120244

(51) Int. Cl. H04W 36/30; H04B 17/318; H04L 1/1812; H04W 72/21

(52) U.S. Cl. CPC H04W 36/30; H04B 17/328; H04L 1/1812; H04W 72/21

(57) ABSTRACT

A method and apparatus to support RACH-less handover is provided. The method for supporting RACH-less handover includes receiving from a base station a radio resource control (RRC) message for RACH-less handover, selecting a configured grant for RACH-less handover based on a specific set of parameters, performing uplink transmission based on a specific occasion of the configured grant. The terminal in first period selects a first synchronization signal/physical broadcast channel block (SSB) from a plurality of specific SSBs and considers the configured grant for RACH-less handover as valid. The terminal in second period considers the configured grant for RACH-less handover as valid in case that a SSB associated with the configured grant for RACH-less handover has same SSB index with the first SSB.

### CROSS-REFERENCE TO RELATED APPLICATION

This application claims priority to and the benefit of Korean Patent Application Nos. 10-2024-0159712, filed on Nov. 11, 2024, and 10-2025-0120244, filed on Aug. 27, 2025. Each of the above documents is hereby incorporated herein by reference in its entirety.

### BACKGROUND

### Technical Field

The present disclosure relates to RACH-less handover in mobile communication system.

### Related Art

Handover is a critical process in cellular networks that allows a user equipment (UE) to switch from one base station to another while maintaining connectivity. Traditionally, handover procedures have relied on the Random Access Channel (RACH) to establish initial uplink synchronization with the target cell. However, this RACH-based approach introduces latency and potential interruptions in data connectivity during the handover process.

To address these limitations, RACH-less handover has emerged as an innovative solution, particularly in scenarios where network synchronization is feasible. RACH-less handover aims to significantly reduce handover interruption time and improve overall mobility robustness by eliminating the need for the RACH procedure.

The implementation of RACH-less handover presents opportunities for enhancing user experience, especially in dense network deployments and scenarios requiring frequent handovers.

### SUMMARY

Aspects of the present disclosure are to address the problems of performing RACH-les s handover in mobile communication system. The method includes receiving from a base station a radio resource control (RRC) message for RACH-less handover, selecting a configured grant for RACH-less handover based on a specific set of parameters, performing uplink transmission based on a specific occasion of the configured grant. The terminal in first period selects a first synchronization signal/physical broadcast channel block (SSB) from a plurality of specific SSBs and considers the configured grant for RACH-less handover as valid. The terminal in second period considers the configured grant for RACH-less handover as valid in case that a SSB associated with the configured grant for RACH-less handover has same SSB index with the first SSB.

### BRIEF DESCRIPTION OF THE DRAWINGS

FIG. 1A is a diagram illustrating the architecture of an 5G system and a NG-RAN;

FIG. 1B is a diagram illustrating a wireless protocol architecture in an 5G system;

FIG. 2A illustrates overall operation of the UE and network.

FIG. 2B illustrates the operation of the UE regarding PLMN selection and cell selection and cell reselection.

FIG. 2C illustrates RRC connection establishment procedure.

FIG. 2D illustrates UE capability transfer procedure.

FIG. 2E illustrates RRC connection reconfiguration procedure.

FIG. 2F illustrates data transfer procedure in RRC_CONNECTED state.

FIG. 3A illustrates random access procedure.

FIG. 3B illustrates scheduling request procedure based on dedicate scheduling request resource.

FIG. 4A is a diagram illustrating operations of the terminal and the base station for RACH-less handover.

FIG. 4B illustrates ASN.1 of various IEs.

FIG. 4C illustrates ASN.1 of various IEs.

FIG. 4D illustrates ASN.1 of various IEs.

FIG. 5A is a diagram illustrating operations of the terminal.

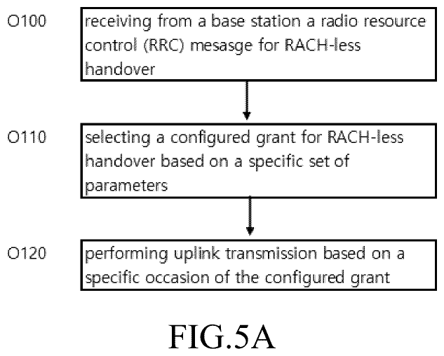

FIG. 6A is a block diagram illustrating the internal structure of a UE to which the disclosure is applied.

FIG. 6B is a block diagram illustrating the configuration of a base station according to the disclosure.

### DETAILED DESCRIPTION

The present disclosure addresses these challenges by introducing an optimized BSR mechanism tailored specifically for XR applications within 5G networks. This disclosure aims to enhance data throughput, reduce latency, and improve overall network performance, thereby providing a more immersive and responsive XR experience.

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, “trigger” or “triggered” and “initiate” or “initiated” can be used interchangeably.

In the present disclosure, UE and terminal and wireless device can be used interchangeably. In the present disclosure, NG-RAN node and base station and GNB can be used interchangeably.

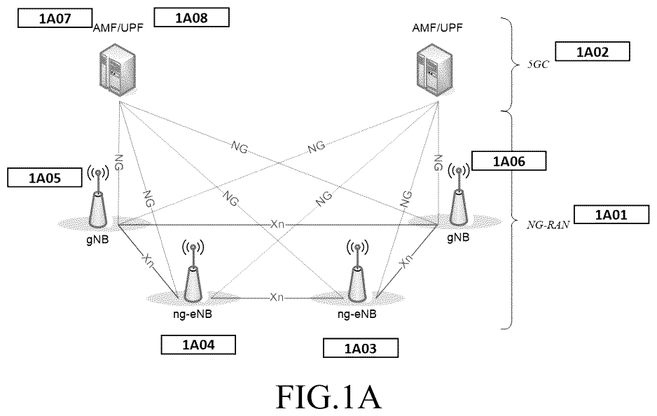

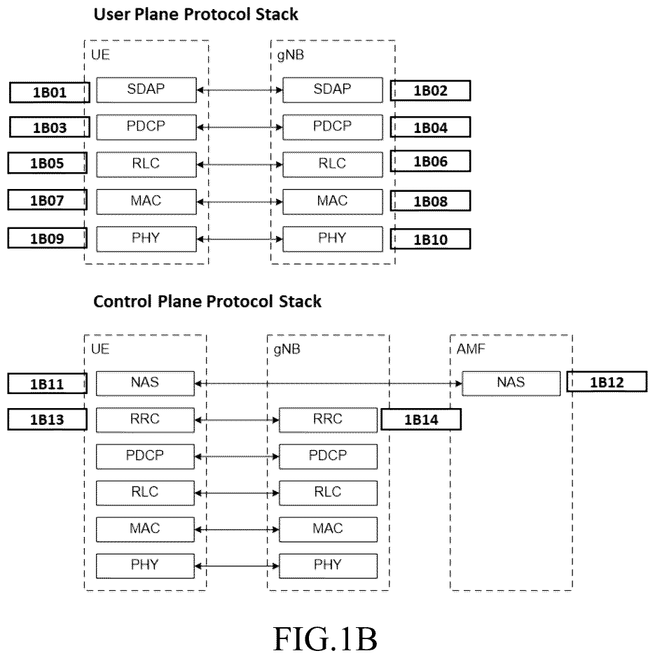

FIG. 1A is a diagram illustrating the architecture of an 5G system and a NG-RAN to which the disclosure may be applied.

5G system consists of NG-RAN 1A01 and 5GC 1A02. An NG-RAN node is either:
1: a gNB, providing NR user plane and control plane protocol terminations towards the UE; or
1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.
1: Functions for Radio Resource Management such as Radio Bearer Control, Radio Admission Control, Connection Mobility Control, Dynamic allocation of resources to UEs in uplink, downlink and sidelink (scheduling); and
1: IP and Ethernet header compression, uplink data decompression and encryption of user data stream; and
1: Selection of an AMF at UE attachment when no routing to an MME can be determined from the information provided by the UE; and
1: Routing of User Plane data towards UPF; and
1: Scheduling and transmission of paging messages; and
1: Scheduling and transmission of broadcast information (originated from the AMF or O&M); and
1: Measurement and measurement reporting configuration for mobility and scheduling; and
1: Session Management; and
1: QoS Flow management and mapping to data radio bearers; and
1: Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

FIG. 1B is a diagram illustrating a wireless protocol architecture in an 5G system to which the disclosure may be applied.

User plane protocol stack consists of SDAP 1B01 or 1B02, PDCP 1B03 or 1B04, RLC 1B05 or 1B06, MAC 1B07 or 1B08 and PHY 1B09 or 1B10. Control plane protocol stack consists of NAS 1B11 or 1B12, RRC 1B13 or 1B14, PDCP, RLC, MAC and PHY.

Each protocol sublayer performs functions related to the operations listed below.

NAS: authentication, mobility management, security control etc.

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

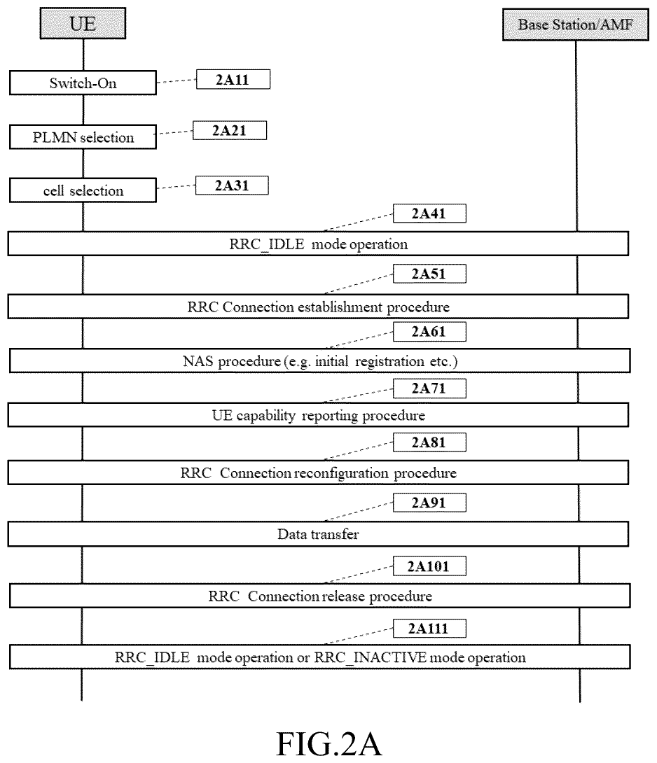

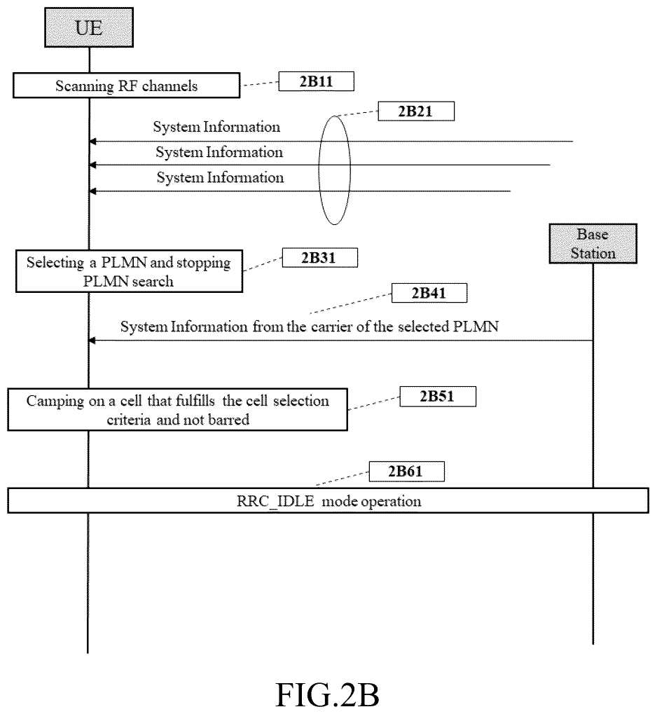

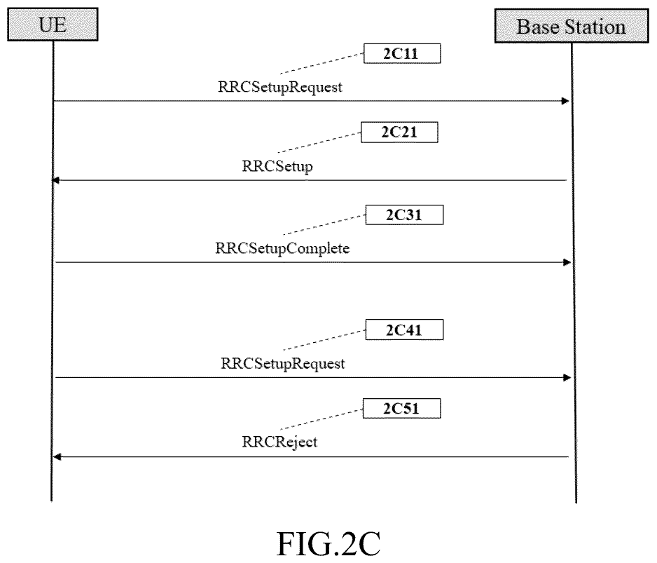

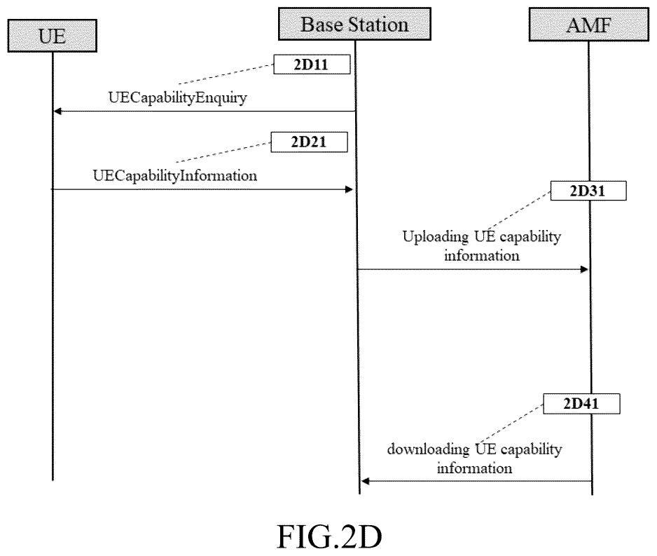

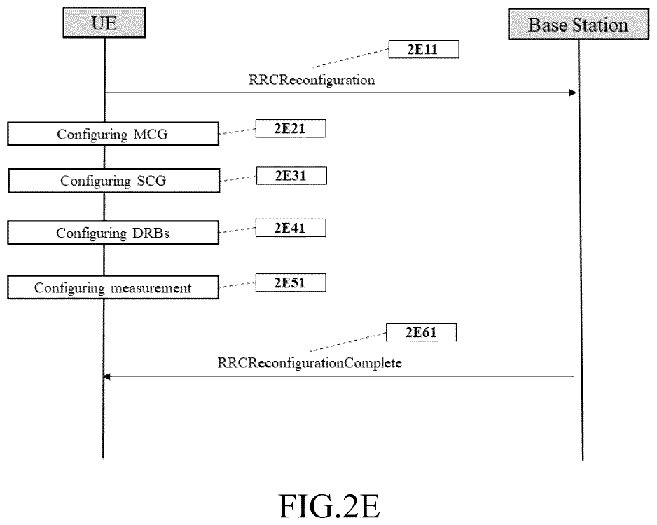

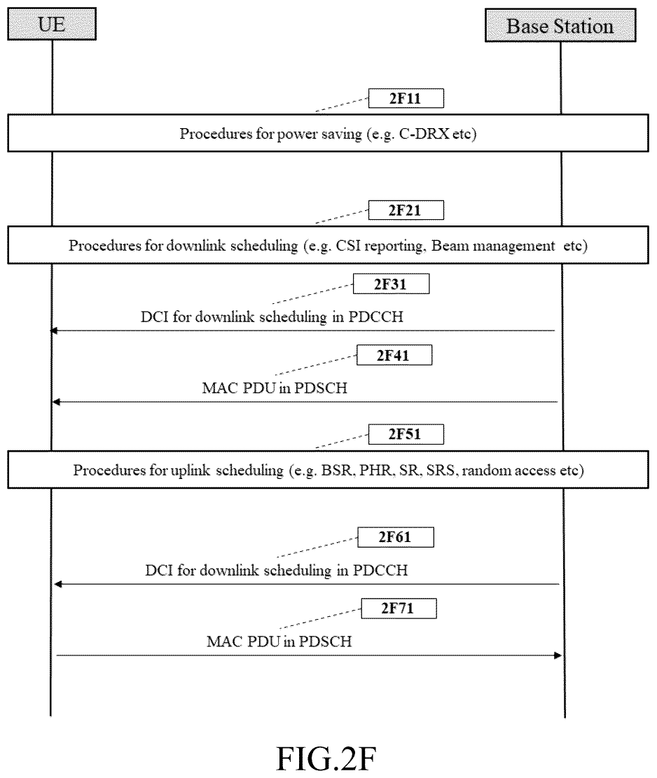

FIG. 2A illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc.) and various RRC functions (such as RRM and RLM and measurement etc.) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is no longer needed for the UE because of e.g. no more traffic available for the UE, the base station and the UE perform RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

FIG. 2B illustrates the operation of the UE regarding PLMN selection and cell selection and cell reselection.

For PLMN selection, the UE may scan all RF channels to find available PLMNs 2B11. On each carrier, the UE shall search for the strongest cell and read its system information 2B21, in order to find out which PLMN(s) the cell belongs to. Each found PLMN is considered as a high quality PLMN (but without the RSRP value) provided that the measured RSRP value is greater than or equal to −110 dBm.

The search for PLMNs may be stopped when the PLMN to which the UE can register is found 2B31.

Once the UE has selected a PLMN, the cell selection procedure shall be performed in order to select a suitable cell of that PLMN to camp on.

The UE performs measurement on detectable cells and receives system information from whichever detectable cells that system information is readable 2B41.

The UE considers cell selection criterion S is fulfilled when:

Srxlev>0 AND

Squal>0
where, Srxlev is Cell selection RX level value (dB) and Squal is Cell selection quality value (dB). Srxlev is determined based on Measured cell RX level value (RSRP). Squal is determined based on Measured cell quality value (RSRQ).

The UE selects the cell that is part of the selected PLMN, and for which cell selection criteria are fulfilled, and of which cell access is not barred 2B51.

The UE camps on the selected cell. The UE performs RRC_IDLE mode operation 2B61 such as monitoring control channels to receive system information and paging and notification message.

FIG. 2C illustrates RRC connection establishment procedure.

Successful RRC connection establishment procedure comprises:
1: transmission of RRCSetupRequest by the UE 2C11;
1: reception of RRCSetup by the UE 2C21;
1: transmission of RRCSetupComplete by the UE 2C31.

Unsuccessful RRC connection establishment procedure comprises:
1: transmission of RRCSetupRequest by the UE 2C41;
1: reception of RRCReject by the UE 2C51;

RRCSetupRequest comprises following fields and IEs:
1: ue-Identity field contains InitialUE-Identity IE which contains:
   2: ng-5G-S-TMSI-Part1 field containing a BIT STRING of 39 bit;
1: establishmentCause field contains EstablishmentCause IE which contains:
   2 enumerated value indicating either emergency, highPriorityAccess, mt-Access, mo-Signalling, mo-Data, mo-VoiceCall, mo-VideoCall, mo-SMS, mps-PriorityAccess, mcs-Priority Access etc

RRCSetup comprises following fields and IEs:
1: radioBearerConfig field containing a RadioBearerConfig IE;
1: masterCellGroup field containing a CellGroupConfig IE.

RRCSetupComplete comprises following fields and IEs:
1: selectedPLMN-Identity field containing an integer indicating selected PLMN;
1: dedicatedNAS-Message field containing a DedicatedNAS-Message which may contain various NAS message;
1: ng-5G-S-TMSI-Part2 field containing a BIT STRING of 9 bit.

RRCSetupRequest is transmitted via CCCH/SRB0, which means that the base station does not identify UE transmitting the message based on DCI that scheduling the uplink transmission. The UE includes a field (ue-Identity) in the message so that the base station identifies the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
1: perform the cell group configuration procedure in accordance with the received masterCellGroup;
1: perform the radio bearer configuration procedure in accordance with the received radioBearerConfig;
1: if stored, discard the cell reselection priority information provided by the cellReselectionPriorities or inherited from another RAT;
1: enter RRC_CONNECTED;
1: stop the cell re-selection procedure;
1: consider the current cell to be the PCell;

The UE transmits to the base station RRCSetupComplete after performing above actions.

The UE sets the contents of RRCSetupComplete message as follows:
1: set the ng-5G-S-TMSI-Value to ng-5G-S-TMSI-Part2;
1: set the selectedPLMN-Identity to the PLMN selected by upper layers from the plmn-Identity InfoList;
1: include the s-NSSAI-List and set the content to the values provided by the upper layers;

FIG. 2D illustrates UE capability transfer procedure.

For network to configure the UE with appropriate configurations, the network needs to know the capability of the UE. For this end, the UE and the base station perform UE capability transfer procedure.

UE capability transfer procedure consists of exchanging UECapabilityEnquiry 2D11 and UECapabilityInformation 2D21 between the UE and the base station.

In the UECapabiliityEnquiry, the base station indicates which RAT is subject to capability reporting. UE transmits the capability information for the requested RAT in the UECapabilityInformation.

Once UECapabilityInformation is received, the capability information is uploaded to the AMF by the base station 2D31. When UE capability information is needed afterward, AMF provides it to the base station 2D41.

FIG. 2E illustrates RRC connection reconfiguration procedure.

Based on the reported capability and other factors such as required QoS and call admission control etc, the base station performs RRC reconfiguration procedure with the UE.

RRC reconfiguration procedure is a general purposed procedure that are applied to various use cases such as data radio bearer establishment, handover, cell group reconfiguration, DRX configuration, security key refresh and many others.

RRC reconfiguration procedure consists of exchanging RRCReconfiguration 2E11 and RRCReconfigurationComplete 2E61 between the base station and the UE.

RRCReconfiguration may comprise following fields and IEs:
1: rrc-TransactionIdentifier field contains a RRC-TransactionIdentifier IE;
1: radioBearerConfig field contains a RadioBearerConfig IE;
   2: radioBearerConfig field comprises configuration information for SRBs and DRBs via which RRC messages and user traffic are transmitted and received;
1: secondaryCellGroup field contains a CellGroupConfig IE;
   2: secondaryCellGroup field comprises configuration information for secondary cell group;
   2: A cell group consists of a SpCell and zero or more SCells;
   2: Cell group configuration information comprises cell configuration information for SpCell/SCell and configuration information for MAC and configuration information for logical channel etc;
1: measConfig field contains a MeasConfig IE;
   2: measConfig field comprises configuration information for measurements that the UE is required to perform for mobility and other reasons.
1: masterCellGroup field contains a CellGroupConfig IE;

Upon reception of RRCReconfiguration, UE processes the IEs in the order as below. UE may:
1: perform the cell group configuration for MCG based on the received masterCellGroup 2E21;
1: perform the cell group configuration for SCG based on the received secondaryCellGroup 2E31;
1: perform the radio bearer configuration based on the received radioBearerConfig 2E41;
1: perform the measurement configuration based on the received measConfig 2E51;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

FIG. 2F illustrates data transfer procedure in RRC_CONNECTED state.

The UE and the base station may perform procedures for power saving such as C-DRX 2F11. The configuration information for C-DRX is provided to the UE within cell group configuration in the RRCReconfiguration.

The UE and the base station may perform various procedures for downlink scheduling 2F21 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 2F31.

The base station transmits to the UE PDSCH corresponding to the DCI and containing a MAC PDU 2F41.

The UE and the base station may perform various procedures for uplink scheduling 2F51 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 2F61. The base station transmits to the UE PDSCH corresponding to the DCI and containing a MAC PDU 2F71.

FIG. 2G illustrates RRC connection release procedure.

RRC connection release procedure comprises:
1: transmission of RRCRelease from the base station to the UE 2G11; and
1: transmission of acknowledgement for the RRCRelease from the UE to the base station 2G21; and
1: state transition from RRC_CONNECTED to either RRC_IDLE or RRC_INACTIVE 2G31.

The purpose of RRC connection release procedure is either to release RRC connection (state transition to RRC_IDLE) or to suspend RRC connection (state transition to RRC_INACTIVE).

RRC connection release procedure may perform, in addition to state transition, various roles e.g., providing redirection information or providing cell reselection priorities.

The RRCRelease may comprise following fields for redirection:
1: redirectedCarrierInfo field comprises RedirectedCarrierInfo IE;
   2: RedirectedCarrierInfo IE comprises either CarrierInfoNR IE or RedirectedCarrierInfo-EUTRA IE;
      3: CarrierInfoNR IE comprises ARFCN-ValueNR IE and SubcarrierSpacing IE; The UE may perform cell selection on the carrier indicated by CarrierInfoNR IE or RedirectedCarrierInfo-EUTRA IE.

The RRCRelease may comprise following fields to configure cell reselection priority:
1: cellReselectionPriorities field comprises CellReselectionPriorities IE;
   2: CellReselectionPriorities IE comprises:
      3: FreqPriorityListNR IE;
      3: t320 field indicates a timer value for cell reselection priority validity;

During idle mode mobility, the UE applies the CellReselectionPriorities until T320 expires or stops.

The RRCRelease may comprise following fields/IEs to transition UE to RRC_INACTIVE state:
1: suspendConfig field comprises SuspendConfig IE;
   2: fullI-RNTI field comprises I-RNTI-Value IE;
   2: shortI-RNTI field comprises ShortI-RNTI-Value IE;
   2: ran-PagingCycle field comprises PagingCycle IE;
   2: ran-NotificationAreaInfofield comprises RAN-NotificationAreaInfo IE;
   2: t380 field comprises PeriodicRNAU-TimerValue;
   2: nextHopChainingCount field comprises NextHopChainingCount IE.
   2: ran-ExtendedPagingCycle field comprises ExtendedPagingCycle IE.

To transit the UE to RRC_INACTIVE, the base station includes SuspendConfig IE in the RRCRelease. To transit the UE to RRC_IDLE, the base station does not include SuspendConfig IE in the RRCRelease.

Upon reception of RRCRelease, UE may:
1: delay the actions caused by RRCRelease 60 ms from the moment the RRCRelease message was received or optionally when lower layers indicate that the receipt of the RRCRelease message has been successfully acknowledged, whichever is earlier;
1: store the cell reselection priority information provided by the cellReselectionPriorities and start T320;
1: if the RRCRelease includes suspendConfig:
   2: reset MAC and release the default MAC Cell Group configuration;
   2: apply the received suspendConfig except the received nextHopChainingCount;
   2: if the sdt-Config is configured:
      3: for each of the DRB in the sdt-DRB-List, consider the DRB to be configured for SDT;
      3: if sdt-SRB2-Indication is configured, consider the SRB2 to be configured for SDT;
      3: re-establish the RLC entity for each RLC bearer that is not suspended;
      3: trigger the PDCP entity to perform SDU discard for SRB1 and SRB2;
   3: if sdt-MAC-PHY-CG-Config is configured, configure the PCell with the configured grant resources for SDT and start the cg-SDT-TimeAlignmentTimer;
      3: if srs-PosRRC-Inactive is configured, apply the configuration and instruct MAC to start the inactivePosSRS-TimeAlignmentTimer;
   2: re-establish RLC entities for SRB1;
   2: stop the timer T319 if running;
   2: store in the UE Inactive AS Context the nextHopChainingCount received in the RRCRelease message, the current KgNB and KRRCint keys, the ROHC state, the EHC context(s), the UDC state, the stored QoS flow to DRB mapping rules, the application layer measurement configuration, the C-RNTI used in the source PCell, the cellIdentity and the physical cell identity of the source PCell, the spCellConfigCommon within Reconfiguration WithSync of the NR PSCell (if configured) and all other parameters configured except for:
      3: parameters within Reconfiguration WithSync of the PCell;
      3: parameters within Reconfiguration WithSync of the NR PSCell, if configured;
      3: parameters within MobilityControlInfoSCG of the E-UTRA PSCell, if configured;
      3: servingCellConfigCommonSIB;
   2: suspend all SRB(s) and DRB(s) and multicast MRB(s), except SRB0 and broadcast MRBs;
   2: indicate PDCP suspend to lower layers of all DRBs and multicast MRBs;
   2: start timer T380, with the timer value set to t380;
   2: indicate the suspension of the RRC connection to upper layers;
   2: enter RRC_INACTIVE and perform cell selection;
1: else (if the RRCRelease does not include suspendConfig):
   2: perform the actions upon going to RRC_IDLE;

FIG. 2H illustrates RRC connection resumption procedure.

RRC connection resume procedure, in case of state transition from RRC_INACTIVE to RRC_CONNECTED, consists of RRC message exchange between the UE and the base station: RRCResumeRequest 2H11 and RRCResume 2H21 and RRCResumeComplete 2H31.

RRC connection resume procedure, in case of small data transmission without state transition, consists of RRC message exchange between the UE and the base station: RRCResumeRequest 2H41 and RRCRelease 2H51.

RRC connection resume procedure is triggered by the UE due to various reasons. For example, RRC connection resume procedure for state transition is triggered periodically (upon T380 expiry) or event-driven (upon cell change to different RAN area) or data driven (upon uplink or downlink data arrival). RRC connection resume procedure for small data transmission is triggered only if channel condition is above specific threshold and the amount of data is expected to be relatively small.

Upon initiation of RRC connection resume procedure, the UE performs some preliminary operation such as starting timers such as T319 (for supervising the procedure) and timeAlignmentTimer (for uplink timing alignment) and applying common channel configuration (for transmission of RRCResumeRequest). Then UE transmits RRCResumeRequest 2H11 or 2H41 to the base station. The message comprises the UE identifier which can be used by the base station to identify the UE context where RRC connection information of the UE is stored.

When the base station determines that UE needs to be in RRC_CONNECTED state, the base station transmits RRCResume. Upon reception of RRCResume 2H21, the UE restores whole UE context based on the stored context at the time of RRCRelease reception and the received information in the RRCResume.

If the RRC connection resume procedure is triggered for small data transmission, the UE and the base station may perform data transfer during RRC connection resume procedure 2H51. When the base station determines that small data transmission is finished, the base station transmits RRCRelease 2H61.

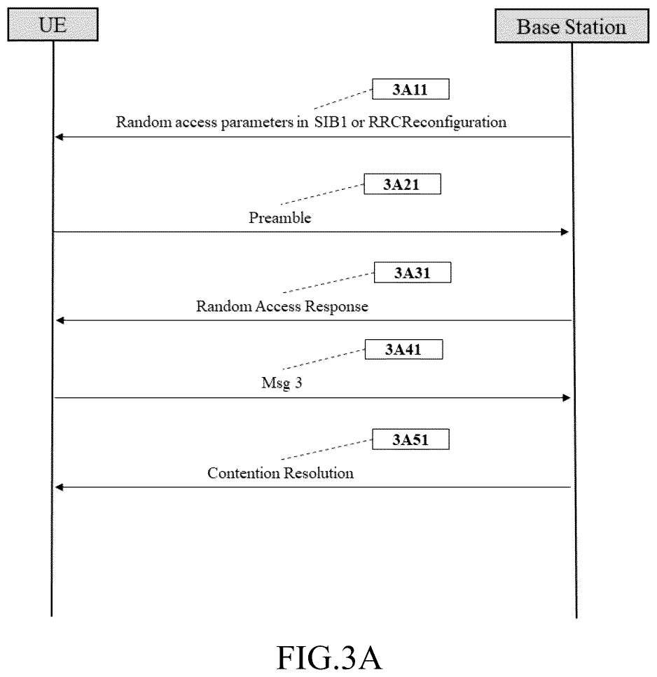

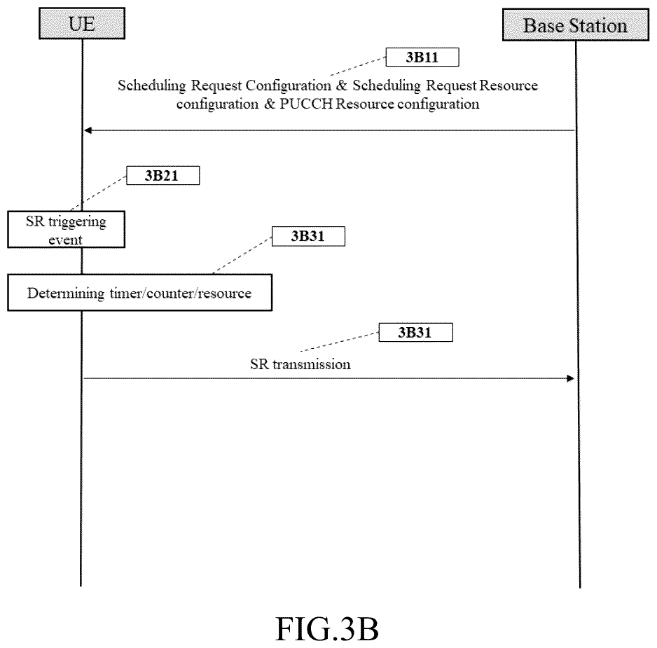

FIG. 3A illustrates random access procedure.

Random access procedure enables the UE to align uplink transmission timing, and indicate the best downlink beam, and transmit a MAC PDU that may contain CCCH SDU (e.g. RRCSetupRequest).

Random access procedure comprises preamble transmission 3A21, random access response reception 3A31, Msg 3 transmission 3A41 and contention resolution 3A51.

Parameters for random access procedure are provided in SIB1 (in case of initial access) or in RRCReconfiguration (in case of handover) 3A11.

Random access procedure may be triggered by a number of events such as initial access from RRC_IDLE (e.g. RRC connection establishment procedure), DL or UL data arrival, request by RRC upon synchronous reconfiguration (e.g. handover) and RRC Connection Resume procedure from RRC_INACTIVE etc.

When the random access procedure is initiated, the UE may perform following actions in order:
1: flush the buffer for Msg 3;
1: initialize the counters for preamble transmission and power ramping;
1: select the uplink carrier for performing the random access procedure based on a rsrp threshold (e.g. rsrp-ThresholdSSB-SUL);
1: select the set of Random Access resources applicable to the current Random Access procedure;
1: select a SSB based on a rsrp threshold (e.g. rsrp-ThresholdSSB); a SSB corresponds to a downlink beam;
1: select a random access preamble group based on the pathloss of the selected SSB and the potential Msg3 size and various parameters (e.g. ra-Msg3SizeGroupA, preambleReceivedTargetPower, msg3-DeltaPreamble, messagePowerOffsetGroupB etc); Preamble group selection enables the UE to request bigger uplink grant for Msg 3 transmission if channel condition is good enough and the potential Msg 3 size is above a certain threshold;
1: select a random access preamble randomly with equal probability from the random access preambles associated with the selected SSB and the selected random access preamble group;
1: determine the next available PRACH occasion from the PRACH occasions corresponding to the selected SSB;
1: determine the transmission power of the preamble;
   2: preamble transmission power=pathloss+preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA
1: transmit the preamble in the determined PRACH occasion with the determined transmission power;
1; start ra-Response Window;
1: monitor the PDCCH of the SpCell for Random Access Response(s) identified by the RA-RNTI while the ra-Response Window is running;
1: receive Random Access Response contains a MAC subPDU with Random Access Preamble identifier corresponding to the transmitted preamble;
1: process the received Timing Advanced Command and the received UL grant;
1: transmit a Msg 3 based on the received UL grant;
   2: Msg 3 may contain e.g. CCCH SDU such as RRCSetupRequest or RRCResumeRequest;
1: start ra-ContentionResolutionTimer;
1: monitor the PDCCH while the ra-ContentionResolutionTimer is running;
1: consider Contention Resolution successful when MAC PDU containing a UE Contention Resolution Identity MAC CE is received;
1: consider the Random Access procedure successfully completed.

FIG. 3B illustrates scheduling request procedure based on dedicate scheduling request resource.

Unlike downlink traffic, the scheduler in the base station does not know when UE needs to be scheduled for uplink transmission. To enable uplink scheduling, the UE can be configured with scheduling request resource. When uplink resource is required for the UE, the UE can transmit a one-bit signal on the scheduling request resource based on the scheduling request procedure.

The base station provides to the UE configuration information for dedicate scheduling request procedure in RRCReconfiguration 3B11.

The configuration information comprises four main components: mapping information between events and the counter/timer/time resource/frequency resource, configuration information for counter/timer, configuration information for time resource, and configuration information for frequency resource.

One or more instances of configuration information on counter/timer (e.g. SchedulingRequestToAddMod) can be provided to the UE; each of them is associated with an identifier (e.g. schedulingRequestId). An initial value for counter (e.g. sr-TransMax) defines the number of consecutive times for SR transmission that is allowed. The timer (sr-Prohibittimer) defines the minimum time duration between the consecutive SR transmission.

One or more instances of configuration information on scheduling request resource (e.g. SchedulingRequestResourceConfig) can be provided to the UE; each of them is associated with an identifier (schedulingRequestID). The configuration information further comprises time domain information for the resource (e.g. periodicity AndOffset) and the identifier of the associated timer/counter (schedulingRequestResourceId) and the identifier of the associated frequency domain resource (PUCCH-ResourceId).

One or more instances of configuration information on PUCCH resource (e.g. PUCCH-Resource) can be provided to the UE; each of them is associated with an identifier (e.g. PUCCH-ResourceId). The configuration information comprises identifier of PRB where the PUCCH resource starts and an indication whether intra-slot frequency hopping is enabled.

The base station can indicate UE which counter/timer shall be used for which SR triggering event by binding the SR triggering event with a schedulingRequestId.

SR triggering event can be: data arrival in logical channel, SCell beam failure recovery, positioning measurement gap activation/deactivation request etc.

When an SR triggering event occurs 3B21, the UE determines the associated counter/timer based on the mapping information between SR triggering event and schedulingRequestId. Based on the determined schedulingRequestID, the UE determines the associated PUCCH-Resource and the associated SchedulingRequestResource 3B31; more specifically, the UE determines that the SchedulingRequestResource of which configuration information comprises schedulingRequestID is the SchedulingRequestResource associated with the timer/counter identified by the schedulingRequestID.

The UE transmits the SR:
1: in the time/frequency resource determined from SchedulingRequestResource associated with the schedulingRequestId; and
1: based on the prohibit timer and the initial counter value determined from the schedulingRequestId.

SchedulingRequestToAddMod and SchedulingRequestResource have one to one relationship between them.

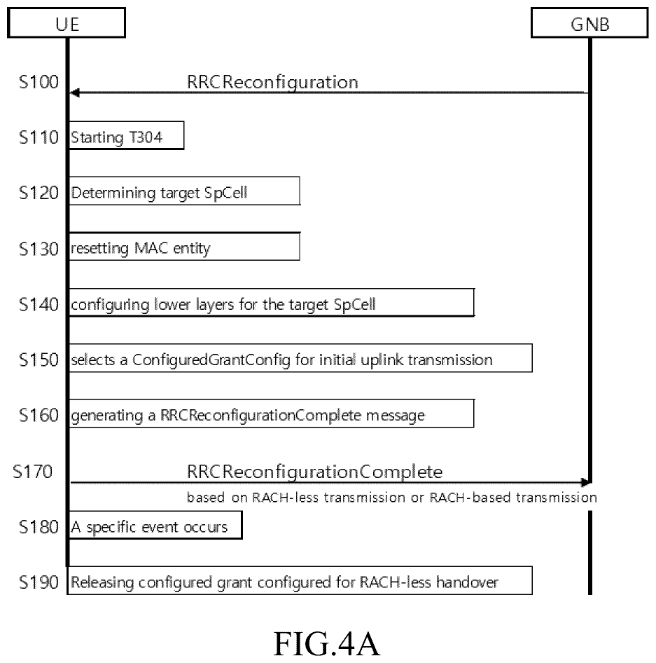

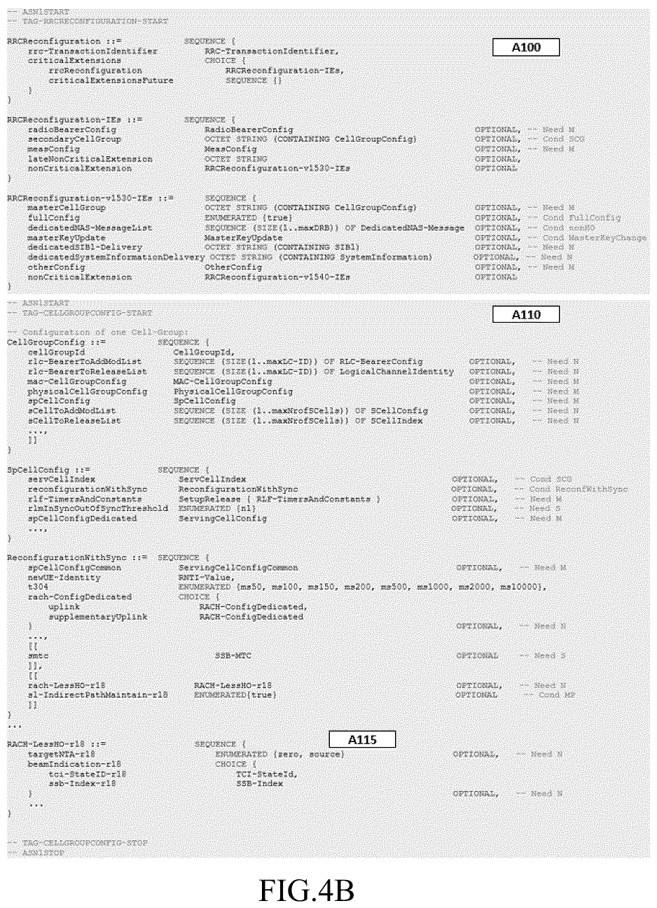

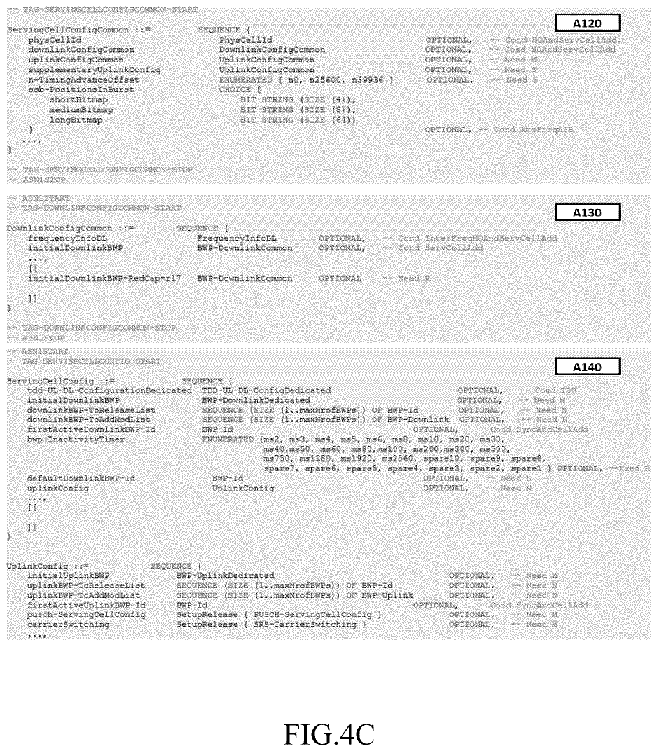

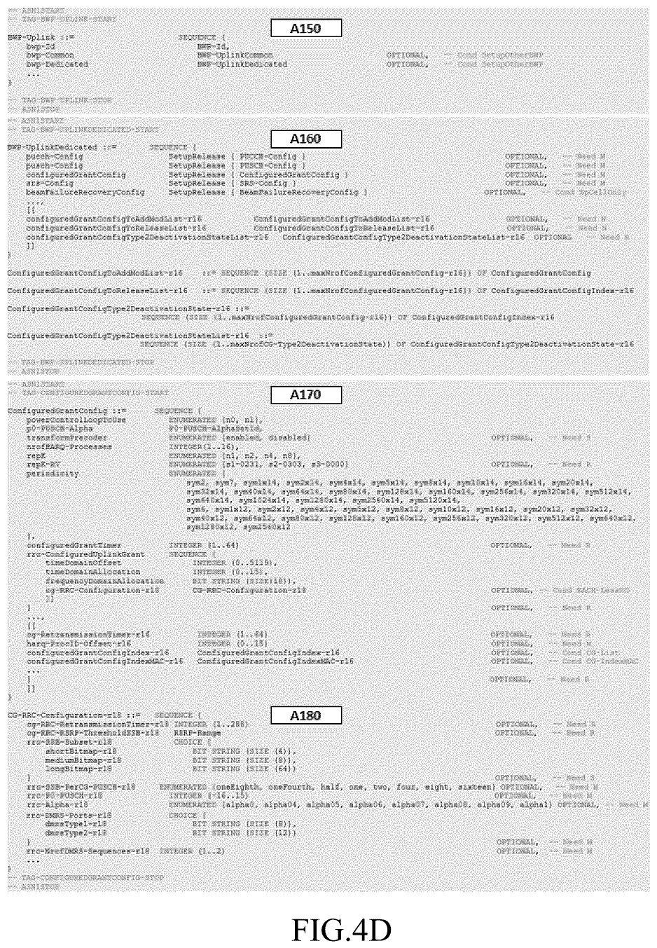

FIG. 4A illustrates operations of UE and GNB for RACH-less handover.

At S100, UE receives from the GNB a RRCReconfiguration message (A100). The message includes CellGroupConfig (A110). Based on CellGroupConfig, UE starts synchronous reconfiguration (reconfigration with sync) procedure towards a target SpCell. Synchronous reconfiguration is equivalent to handover and cell level mobility.

At S110, UE starts T304. The initial value of T304 is determined from t304 field within ReconfigurationWithSync IE.

T304 is a timer to determine whether synchronous reconfiguration is successful or not. UE stops T304 when the synchronous reconfiguration is successfully completed. UE performs RRC connection reestablishment procedure.

At S120, UE determines target SpCell based on frequencyInfoDL and physCellId field. These fields are included in DownlinkConfigCommon IE (A130) within ServingCellConfigCommon IE (A120) within ReconfigurationWithSync IE.

If the frequencyInfoDL is included, UE considers the target SpCell to be a cell:
that is on the SSB frequency indicated by the frequency InfoDL; and
that has a physical cell identity indicated by the physCellId.

If the frequencyInfoDL is included, UE considers the target SpCell to be a cell:
that is on the SSB frequency of the source SpCell; and
that has a physical cell identity indicated by the physCellId.

At S130, UE resets MAC entity. UE releases configured uplink grants in all BWPs of all serving cells.

At S140, UE configures lower layers in accordance with:
the received spCellConfigCommon field that includes ServigCellConfigCommon (A120);
rach-LessHO (A115) for the target SpCell; and
ServingCellConfig (A140) in the received reconfiguration WithSync.

At S150, UE selects a ConfiguredGrantConfig for initial uplink transmission in the target SpCell in case that:
rach-LessHO field is included in ReconfigurationWithSync; and
cg-RRC-Configuration is included in the ConfiguredGrantCofig.

ServingCellConfig may include plurality of BWP-Uplink (A150). Each BWP-Uplink includes a BWP-UplinkDedicated. A BWP-UplinkDedicated (A160) may include plurality of ConfiguredGrantConfig (A170).

UE selects, among plurality of ConfiguredGrantConfig IEs in a specific BWP-UplinkDedicated, the ConfiguredGrantConfig configured with CG-RRC-Configuration (A180). That UE selects a ConfiguredGrantConfig IE is equivalent to that UE selects a configured grant and associated parameters.

cg-RetransmissionTimer indicates the initial value of the configured retransmission timer in multiples of periodicity.

configuredGrantTimer indicates the initial value of the configured grant timer in multiples of periodicity.

frequencyDomainAllocation indicates the frequency domain resource allocation.

periodicity indicates Periodicity for configured uplink grant.

rrc-ConfiguredUplinkGrant is configuration for “configured grant” transmission with fully RRC-configured UL grant (Type1). If this field is absent the UE uses UL grant configured by DCI addressed to CS-RNTI (Type2).

cg-RRC-RSRP-ThresholdSSB indicates an RSRP threshold configured for SSB selection for the CG.

cg-RRC-RetransmissionTimer indicates the initial value of the configured grant retransmission timer used for the initial transmission of CG with DCCH message in multiples of periodicity.

rrc-DMRS-Ports indicates the set of DMRS ports for SSB to PUSCH mapping. The first (left-most/most significant) bit corresponds to DMRS port 0, the second most significant bit corresponds to DMRS port 1, and so on. A bit set to 1 indicates that this DMRS port is used for mapping.

rrc-NrofDMRS-Sequences indicates the number of DMRS sequences for SSB to PUSCH mapping.

rrc-SSB-Subset indicates SSB subset for SSB to CG PUSCH mapping within one CG configuration. The first/leftmost bit corresponds to SS/PBCH block index 0, the second bit corresponds to SS/PBCH block index 1, and so on. Value 0 in the bitmap indicates that the corresponding SS/PBCH block is not included in the SSB subset for SSB to CG PUSCH mapping while value 1 indicates that the corresponding SS/PBCH block is included in SSB subset for SSB to CG PUSCH mapping. If this field is absent, UE assumes the SSB set includes all actually transmitted SSBs.

rrc-SSB-PerCG-PUSCH indicates the number of SSBs per CG PUSCH. Value one corresponds to 1 SSBs per CG PUSCH, value two corresponds to 2 SSBs per CG PUSCH and so on.

sdt-P0-PUSCH, rrc-P0-PUSCH indicates P0 value for PUSCH in steps of 1 dB.

sdt-Alpha, rrc-Alpha indicates alpha value for PUSCH. alpha0 indicates value 0 is used, alpha04 indicates value 4 is used and so on.

At S160, UE generates a RRCReconfigurationComplete message. UE prepares transmission of the RRCReconfigurationComplete message via SRB1 based on the new configuration.

At S170, UE performs transmission of the RRCReconfigurationComplete message. If RACH-less handover is performed, the RRCReconfigurationComplete message is transmitted based on initial uplink transmission. The initial uplink transmission is performed based on the selected ConfiguredGrantConfig. If RACH-based handover is performed, the RRCReconfigurationComplete message is transmitted based on PUSCH transmission scheduled by random access response.

At S180, when a specific event occurs, UE considers synchronous reconfiguration is successfully completed. UE stops timer T304.

At S190, UE releases the uplink grant configured for RACH-less handover.

### <UE Operations>

UE determines to perform RACH-based handover in the following cases:
rach-LessHO field is not included in SpCellConfig IE; or
rach-LessHO field is included in SpCellConfig IE, and cg-RRC-Configuration IE is not included in any ConfiguredGrantConfig IE within SpCellConfig IE, and no SSB configured for RACH-less handover with SS-RSRP above cg-RRC-RSRP-ThresholdSSB is available.

UE determines to perform RACH-less handover in the following cases:
rach-LessHO field is included in SpCellConfig IE; and
cg-RRC-Configuration IE is not included in any ConfiguredGrantConfig IE within SpCellConfig IE.

UE determines to perform RACH-less handover in the following cases:
rach-LessHO field is included in SpCellConfig IE;
cg-RRC-Configuration IE is included in a ConfiguredGrantConfig IE within SpCellConfig IE; and
at least one SSB configured for RACH-less handover with SS-RSRP above cg-RRC-RSRP-ThresholdSSB is available.

UE performs following for handover.
receiving from a base station a radio resource control (RRC) message for RACH-less handover O100;
selecting a configured grant for RACH-less handover based on a specific set of parameters [cg-RRC-Configuration] O110; and
performing uplink transmission based on a specific occasion of the configured grant in case that the configured grant is valid O120.
In a first period, the terminal:
   selects a first SSB from a plurality of specific SSBs, wherein the specific SSBs are associated with the configured grant for RACH-less handover; and
   consider the configured grant for RACH-less handover as valid.
In a second period, the terminal considers the configured grant for RACH-less handover as valid in case that a SSB associated with the configured grant for RACH-less handover has same SSB index with the first SSB.
The first period is:
   after the radio resource control message for the RACH-less handover is received; and
before an initial transmission of RACH-less handover is performed.
The second period is:
   after the initial transmission of RACH-less handover is performed; and
   before an uplink grant for new transmission is received on a specific HARQ process.

UE further performs followings.
performing uplink transmission based on a random access instead of the configured grant in case that no SSB of the plurality of specific SSBs meets a condition related to RSRP; and
releasing the configured grant for RACH-less handover after the random access is successfully completed.
The specific set of parameters includes:
   a parameter comprising a bitmap related to the specific SSBs; and
   a parameter indicating number of SSBs per configured grant.
The terminal determines that the specific SSBs are associated with the configured grant for RACH-less handover based on the parameter comprising bitmap.
The specific set of parameters is included in a specific configured grant configuration IE.
The specific configured grant configuration IE includes configuration parameters for the configured grant for RACH-less handover.
The specific configured grant configuration IE is included in the RRC message for RACH-less handover.
First bit of the bitmap corresponds to SSB index 0.
Second bit of the bitmap corresponds to SSB index 1.
Value 0 in the bitmap indicates corresponding SSB is used for SSB to PUSCH mapping.
Value 1 in the bitmap indicates corresponding SSB is used for SSB to PUSCH mapping.
SSB index of a SSB is determined based on DM-RS sequence of the SSB.
a specific SSB indexes are mapped to PUSCH occasions based on the bitmap; and
number of the specific SSB indexes is determined based on number of value 1s in the bitmap.

When rach-LessHO is configured, the MAC entity shall:
if cg-RRC-Configuration is configured:
select a configured uplink grant for initial uplink transmission;
   perform initial uplink transmission in the first available CG occasion for RACH-less handover
   monitor the PDCCH.
else:
   if tci-StateID is configured in rach-LessHO:
      indicate to lower layers the TCI state information included in tci-StateID.
   else if ssb-Index is configured in rach-LessHO:
      indicate to lower layers the SSB index included in ssb-Index.
   monitor the PDCCH.
if an uplink grant for this Serving Cell has been received on the PDCCH for the MAC entity's C-RNTI or Temporary C-RNTI; or
if an uplink grant has been received in a Random Access Response:
   if the uplink grant is for MAC entity's C-RNTI and if the previous uplink grant delivered to the HARQ entity for the same HARQ process was either an uplink grant received for the MAC entity's CS-RNTI or a configured uplink grant:
      consider the NDI to have been toggled for the corresponding HARQ process regardless of the value of the NDI.
   if the uplink grant is for MAC entity's C-RNTI, and the identified HARQ process is configured for a configured uplink grant:
      start or restart the configuredGrantTimer for the corresponding HARQ process, if configured;
      stop the cg-RetransmissionTimer for the corresponding HARQ process, if running.
   stop the cg-SDT-RetransmissionTimer for the corresponding HARQ process, if running.
   stop the cg-RRC-RetransmissionTimer for the corresponding HARQ process, if running.
   if the uplink grant has been received on the PDCCH for the MAC entity's C-RNTI after the first PUSCH transmission to the Serving Cell; and
   if the uplink grant is for a new transmission on the same HARQ process used for the first PUSCH transmission to the Serving Cell:
      if there is an ongoing RACH-less handover procedure:
         consider the RACH-less handover to be successfully completed and indicate to upper layers.
      else if there is an ongoing RACH-less LTM cell switch:
         consider the LTM cell switch to be successfully completed and indicate it to upper layers.
   deliver the uplink grant and the associated HARQ information to the HARQ entity.

For the uplink grant configured for configured grant Type 1 for RACH-less handover, the UE entity shall:
if, after the initial transmission of RACH-less handover has been performed, RACH-less handover is not successfully completed:
   if the SSB corresponding to the configured UL grant has the same SSB index as the SSB selected for the initial transmission of RACH-less handover (i.e., retransmission of initial transmission of RACH-less handover):
      select this SSB;
      indicate the SSB index corresponding to the configured uplink grant to the lower layer;
      consider this configured uplink grant as valid.
else if the initial transmission of RACH-less handover has been initiated and not been performed (if the initial transmission of RACH-less handover has been initiated, the initial transmission of RACH-less handover has not been performed) and at least one SSB corresponding to the configured uplink grant with SS-RSRP above cg-RRC-RSRP-ThresholdSSB is available:
   select an SSB with SS-RSRP above cg-RRC-RSRP-ThresholdSSB amongst the SSB(s) associated with the configured uplink grant;
   indicate the selected SSB index to the lower layer;
   consider this configured uplink grant as valid.
else:
   consider this configured uplink grant as not valid;
   initiate Random Access procedure.

If the UE has a C-RNTI, a Temporary C-RNTI, or CS-RNTI, the MAC entity shall for each PDCCH occasion and for each Serving Cell belonging to a TAG that has a running time AlignmentTimer or a running cg-SDT-TimeAlignmentTimer and for each grant received for this PDCCH occasion:
if an uplink grant for this Serving Cell has been received on the PDCCH for the MAC entity's C-RNTI or Temporary C-RNTI; or
if an uplink grant has been received in a Random Access Response:
   if the uplink grant is for MAC entity's C-RNTI and if the previous uplink grant delivered to the HARQ entity for the same HARQ process was either an uplink grant received for the MAC entity's CS-RNTI or a configured uplink grant:
      consider the NDI to have been toggled for the corresponding HARQ process regardless of the value of the NDI.
   if the uplink grant is for MAC entity's C-RNTI, and the identified HARQ process is configured for a configured uplink grant:
      start or restart the configuredGrantTimer for the corresponding HARQ process, if configured;
      stop the cg-RetransmissionTimer for the corresponding HARQ process, if running.
   stop the cg-SDT-RetransmissionTimer for the corresponding HARQ process, if running.
   stop the cg-RRC-RetransmissionTimer for the corresponding HARQ process, if running.
   if the uplink grant has been received on the PDCCH for the MAC entity's C-RNTI after the first PUSCH transmission to the Serving Cell; and
   if the uplink grant is for a new transmission on the same HARQ process used for the first PUSCH transmission to the Serving Cell:
      if there is an ongoing RACH-less handover procedure:
         consider the RACH-less handover to be successfully completed and indicate to upper layers.
      else if there is an ongoing RACH-less LTM cell switch:
         consider the LTM cell switch to be successfully completed and indicate it to upper layers.
   deliver the uplink grant and the associated HARQ information to the HARQ entity.

A UE indicated to perform PUSCH transmission in RACH-less handover can be provided one or more configurations by respective one or more ConfiguredGrantConfig, for configured grant Type 1 PUSCH transmissions on the initial UL BWP.

A UE can be provided by rrc-SSB-Subset a number of SS/PBCH block indexes N_SS/PBCH_PUSCH to map to a number of valid PUSCH occasions for PUSCH transmissions over an association period. If the UE is not provided rrc-SSB-Subset, the UE determines N_SS/PBCH PUSCH from the value of ssb-PositionsInBurst in ServingCellConfigCommon. A PUSCH occasion for a PUSCH transmission is defined by a time resource and a frequency resource and is associated with a DM-RS provided by cg-DMRS-Configuration for the configuration of PUSCH transmissions. A UE can be provided a number of repetitions for a PUSCH transmission by repK or numberOfRepetitions. If the number of repetitions is provided and larger than 1, all the PUSCH occasions of the repetitions for the PUSCH transmission are mapped to the same SS/PBCH block index(es). For the initial transmission or autonomous retransmission of an initial transport block provided for PUSCH transmission in RACH-less handover, the UE encodes the transport block using redundancy version number 0 if the UE is not provided repK-RV.

The Synchronization Signal and PBCH block (SSB) consists of primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS.

Within the frequency span of a carrier, multiple SSBs can be transmitted. The PCIs of SSBs transmitted in different frequency locations do not have to be unique, i.e. different SSBs in the frequency domain can have different PCIs. However, when an SSB is associated with an RMSI, the SSB is referred to as a Cell-Defining SSB (CD-SSB). A PCell is always associated to a CD-SSB located on the synchronization raster.

When an SSB is not associated with an RMSI, the SSB is referred to as a non-Cell Defining SSB (NCD-SSB), which can be used to perform RLM, BFD, and RRM measurements and measurements for RA resource selection inside the active DL BWP when the active BWP does not contain the CD-SSB. A UE may be configured with multiple SSBs provided that each BWP is configured with at most one SSB (CD-SSB or NCD-SSB).

DM-RS of PBCH is in the first symbol, the second symbol and the third symbol of SSB.

UE determines the 2 LSB bits of a candidate SS/PBCH block index per half frame from a one-to-one mapping with an index of the DM-RS sequence transmitted in the PBCH.

Small Data Transmission (SDT) is a procedure allowing data and/or signalling transmission while remaining in RRC_INACTIVE state (i.e. without transitioning to RRC_CONNECTED state). SDT is enabled on a radio bearer basis and can be initiated either by the UE in case of MO-SDT (Mobile Originated SDT) or by the network in case of MT-SDT (Mobile Terminated SDT). MO-SDT is initiated by the UE only if less than or equal to a configured amount of UL data awaits transmission across all radio bearers for which SDT is enabled, the DL RSRP is above a configured threshold, and a valid SDT resource is available. MT-SDT is initiated by the network with an indication to the UE in a paging message when DL data awaits transmission for radio bearers configured for SDT; based on the indication, the UE initiates the MT-SDT only if the DL RSRP is above a configured threshold. When MT-SDT is initiated by the UE, a resume cause indicating MT-SDT is included in the RRCResumeRequest/RRCResumeRequest1. Maximum duration the SDT procedure can last is dictated by a SDT failure detection timer that is configured by the network. Network can enable MO-SDT, MT-SDT, or both in a cell.

SDT procedure is initiated with either a transmission over RACH (configured via system information) or over Type 1 CG resources (configured via dedicated signalling in RR (Release). The SDT resources can be configured on initial BWP for both RACH and CG. RACH and CG resources for SDT can be configured on either or both of NUL and SUL carriers. The CG resources for SDT are valid only within the PCell of the UE when the RR (Release with suspend indication is received. CG resources are associated with one or multiple SSB(s). For RACH, the network can configure 2-step and/or 4-step RA resources for MO-SDT. When both 2-step and 4-step RA resources for MO-SDT are configured, the UE selects the RA type. If MT-SDT procedure is initiated over RACH, only the RACH resources not configured for SDT can be used by the UE. CFRA is not supported for SDT over RACH.

Once initiated, the SDT procedure is either:
successfully completed after the UE is directed to RRC_IDLE (via RR (Release) or to continue in RRC_INACTIVE (via RRCRelease or RRCReject) or to RRC_CONNECTED (via RRCResume or RRCSetup); or
unsuccessfully completed upon cell re-selection, expiry of the SDT failure detection timer, a MAC entity reaching a configured maximum PRACH preamble transmission threshold, an RLC entity reaching a configured maximum retransmission threshold, or integrity check failure while SDT procedure is ongoing, or expiry of SDT-specific timing alignment timer or configuredGrantTimer while SDT procedure is ongoing over CG and the UE has not received a response from the network after the initial PUSCH transmission.

Upon successful completion of the SDT procedure via an RRCRelease message including resumeIndication, the UE triggers the initiation of RRC Resume procedure. Upon unsuccessful completion of the SDT procedure, the UE transitions to RRC_IDLE.

The initial PUSCH transmission during the SDT procedure includes at least the CCCH message. When using CG resources for initial SDT transmission, the UE can perform autonomous retransmission of the initial transmission if the UE does not receive confirmation from the network (dynamic UL grant or DL assignment) before a configured timer expires. After the initial PUSCH transmission, subsequent transmissions are handled differently depending on the type of resource used to initiate the SDT procedure:

The MAC entity may be configured by RRC with SDT and the SDT procedure may be initiated by RRC layer for MO-SDT or MT-SDT. The SDT procedure initiated for MO-SDT can be performed either by Random Access procedure with 2-step RA type or 4-step RA type (i.e., RA-SDT) or by configured grant Type 1 (i.e., CG-SDT). The SDT procedure initiated for MT-SDT cannot be performed by RA-SDT, but can be performed either by Random Access procedure (i.e., with 2-step RA type or 4-step RA type) or by configured grant Type 1 (i.e., CG-SDT).

DRBs in the sdt-DRB-List are configured for SDT. If sdt-SRB2-Indication is configured, the SRB2 is configured for SDT. RRCRelease message may include sdt-DRB-List and sdt-SRB2-Indication.

A UE indicated to release a dedicated RRC connection can be provided one or more configurations by respective one or more ConfiguredGrantConfig, for configured grant Type 1 PUSCH transmissions on the initial UL BWP. For the remaining of this clause, PUSCH transmissions refer to configured grant Type-1 PUSCH transmissions for a configuration provided by ConfiguredGrantConfig.

A UE can be provided by sdt-SSB-Subset a number of SS/PBCH block indexes N_{PUSCH}^{SS/PBCH} to map to a number of valid PUSCH occasions for PUSCH transmissions over an association period. If the UE is not provided sdt-SSB-Subset, the UE determines N_{PUSCH}^{SS/PBCH} from the value of ssb-PositionsInBurst in SIB1. A PUSCH occasion for a PUSCH transmission is defined by a time resource and a frequency resource and is associated with a DM-RS provided by cg-DMRS-Configuration for the configuration of PUSCH transmissions. A UE can be provided a number of repetitions for a PUSCH transmission by repK or numberOfRepetitions. If the number of repetitions is provided and larger than 1, all the PUSCH occasions of the repetitions for the PUSCH transmission are mapped to the same SS/PBCH block index(es). All the PUSCH occasions of the repetitions are not valid if any PUSCH occasion of the repetitions is not valid.

An association period, starting from frame with SFN 0 and hyper frame with hyper SFN 0, for mapping N_{PUSCH}^{SS/PBCH} SS/PBCH block indexes, from the number of SS/PBCH block indexes, to valid PUSCH occasions and associated DM-RS resources is the smallest value in the set determined by the PUSCH configuration period provided by periodicity in ConfiguredGrantConfig such that N_{PUSCH}^{SS/PBCH} SS/PBCH block indexes are mapped at least once to valid PUSCH occasions and associated DM-RS resources within the association period. A UE is provided a number of SS/PBCH block indexes associated with a PUSCH occasion and a DM-RS resource by sdt-SSB-PerCG-PUSCH. If after an integer number of SS/PBCH block indexes to PUSCH occasions and associated DMRS resources mapping cycles within the association period there is a set of PUSCH occasions and associated DMRS resources that are not mapped to N_{PUSCH}^{SS/PBCH} SS/PBCH block indexes, no SS/PBCH block indexes are mapped to the set of PUSCH occasions and associated DMRS resources. An association pattern period, when PUSCH configuration period is no longer than 640 msec, includes one or more association periods and is determined so that a pattern between PUSCH occasions with associated DMRS resources and SS/PBCH block indexes repeats at most every 640 msec.

PUSCH occasions and associated DMRS resources not associated with SS/PBCH block indexes after an integer number of association periods, if any, are not used for PUSCH transmissions.

For an uplink grant configured for configured grant Type 1 for CG-SDT on the selected uplink carrier, when CG-SDT is triggered and not terminated, for each configured uplink grant, the UE shall:
if, after initial transmission for CG-SDT with CCCH message has been performed, PDCCH addressed to the UE's C-RNTI has not been received:
   if the SSB corresponding to the configured UL grant has the same SSB index as the SSB selected for initial transmission for CG-SDT with CCCH message (i.e., retransmission of initial transmission of CG-SDT):
      select this SSB;
      indicate the SSB index corresponding to the configured uplink grant to the lower layer;
      consider this configured uplink grant as valid.
else if: the initial transmission of CG-SDT with CCCH message has been initiated and not been performed/started (the initial transmission of CG-SDT with CCCH message has been initiated and the initial HARQ transmission of the initial transmission of CG-SDT with CCCH message has not been performed); and at least one SSB configured for CG-SDT with SS-RSRP above cg-SDT-RSRP-ThresholdSSB is available:
   if at least one SSB corresponding to the configured uplink grant with SS-RSRP above the cg-SDT-RSRP-ThresholdSSB is available:
      if this is the initial transmission of CG-SDT with CCCH message after the CG-SDT procedure is initiated (i.e., initial transmission for CG-SDT):
         select an SSB with SS-RSRP above cg-SDT-RSRP-ThresholdSSB amongst the SSB(s) associated with the configured uplink grant.
      else if PDCCH addressed to C-RNTI has been received after the initial transmission of CG-SDT with CCCH message (i.e., subsequent new transmission for CG-SDT):
         if SS-RSRP of the SSB selected for the previous transmission for CG-SDT is above cg-SDT-RSRP-ThresholdSSB and this SSB is associated with this configured uplink grant:
         select this SSB.
         else if SS-RSRP of the SSB selected for the previous transmission for CG-SDT is not above cg-SDT-RSRP-ThresholdSSB:
         select an SSB with SS-RSRP above cg-SDT-RSRP-ThresholdSSB amongst the SSB(s) associated with the configured uplink grant.
      if SSB is selected above:
         indicate the SSB index to the lower layer;
         consider this configured uplink grant as valid.
else (initial transmission for CG-SDT with CCCH message has been performed and PDCCH addressed to the UE's C-RNTI has been received, or no SSB configured for CG-SDT with SS-RSRP above cg-SDT-RSRP-ThresholdSSB is available):
   consider this configured uplink grant as not valid.
   if PDCCH addressed to C-RNTI after the initial transmission of the CG-SDT with CCCH message has been received:
      if there is data available for transmission for at least one RB configured for SDT:
         initiate Random Access procedure.

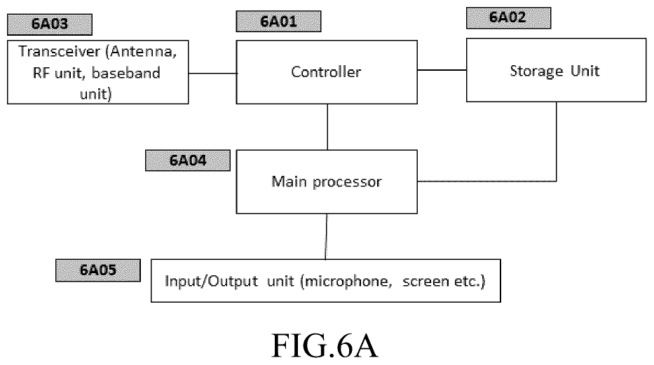

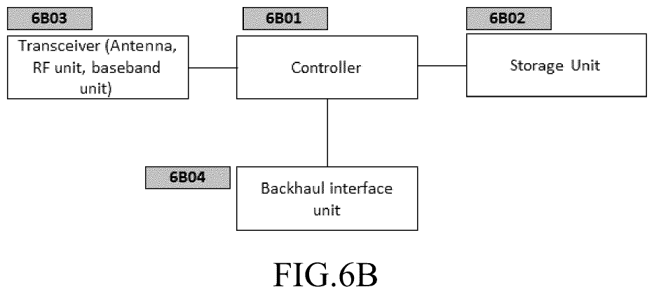

FIG. 6A is a block diagram illustrating the internal structure of a Terminal to which the disclosure is applied.

Referring to the diagram, the terminal includes a controller 6A01, a storage unit 6A02, a transceiver 6A03, a main processor 6A04 and I/O unit 6A05.

The controller 6A01 controls the overall operations of the terminal in terms of mobile communication. For example, the controller 6A01 receives/transmits signals through the transceiver 6A03. In addition, the controller 6A01 records and reads data in the storage unit 6A02. To this end, the controller 6A01 includes at least one processor. For example, the controller 6A01 may include a communication processor (CP) that performs control for communication and an application processor (AP) that controls the upper layer, such as an application program. The controller controls storage unit and transceiver such that UE operations illustrated in this disclosure are performed.

The storage unit 6A02 stores data for operation of the terminal, such as a basic program, an application program, and configuration information. The storage unit 6A02 provides stored data at a request of the controller 6A01.

The transceiver 6A03 consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mil0r, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor 6A04 controls the overall operations other than mobile operation. The main processor 6A04 process user input received from I/O unit 6A05, stores data in the storage unit 6A02, controls the controller 6A01 for required mobile communication operations and forward user data to I/O unit 6A05.

I/O unit 6A05 consists of equipment for inputting user data and for outputting user data such as a microphone and a screen. I/O unit 6A05 performs inputting and outputting user data based on the main processor's instruction.

FIG. 6B is a block diagram illustrating the configuration of a base station according to the disclosure.

As illustrated in the diagram, the base station includes a controller 6B01, a storage unit 6B02, a transceiver 6B03 and a backhaul interface unit 6B04.

The controller 6B01 controls the overall operations of the main base station. For example, the controller 6B01 receives/transmits signals through the transceiver 6B03, or through the backhaul interface unit 6B04. In addition, the controller 6B01 records and reads data in the storage unit 6B02. To this end, the controller 6B01 may include at least one processor. The controller controls transceiver, storage unit and backhaul interface such that base station operation illustrated in FIG. 2A are performed.

The storage unit 6B02 stores data for operation of the main base station, such as a basic program, an application program, and configuration information. Particularly, the storage unit 6B02 may store information regarding a bearer allocated to an accessed UE, a measurement result reported from the accessed UE, and the like. In addition, the storage unit 6B02 may store information serving as a criterion to determine whether to provide the terminal with multi-connection or to discontinue the same. In addition, the storage unit 6B02 provides stored data at a request of the controller 6B01.

The transceiver 6B03 consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit 6B04 provides an interface for communicating with other nodes inside the network. The backhaul interface unit 6B04 converts a bit string transmitted from the base station to another node, for example, another base station or a core network, into a physical signal, and converts a physical signal received from the other node into a bit string.

Below lists acronym used in the present disclosure.

| | | | |
|---|---|---|---|
| 5GC | 5G Core Network | RACH | Random Access Channel |
| ACK | Acknowledgement | RAN | Radio Access Network |
| AM | Acknowledged Mode | RAR | Random Access Response |
| AMF | Access and Mobility Management Function | | |
| RA-RNTI | Random Access RNTI | | |
| ARQ | Automatic Repeat Request | RAT | Radio Access Technology |
| AS | Access Stratum | RB | Radio Bearer |
| ASN.1 | Abstract Syntax Notation One | RLC | Radio Link Control |
| BSR | Buffer Status Report | RNA | RAN-based Notification Area |
| BWP | Bandwidth Part | RNAU | RAN-based Notification Area Update |
| CA | Carrier Aggregation | RNTI | Radio Network Temporary Identifier |
| CAG | Closed Access Group | RRC | Radio Resource Control |
| CG | Cell Group | RRM | Radio Resource Management |
| C-RNTI | Cell RNTI | RSRP | Reference Signal Received Power |
| CSI | Channel State Information | RSRQ | Reference Signal Received Quality |
| DCI | Downlink Control Information | RSSI | Received Signal Strength Indicator |
| DRB | (user) Data Radio Bearer | SCell | Secondary Cell |
| DTX | Discontinuous Reception | SCS | Subcarrier Spacing |
| HARQ | Hybrid Automatic Repeat Request | | |
| SDAP | Service Data Adaptation Protocol | | |
| IE | Information element | SDU | Service Data Unit |
| LCG | Logical Channel Group | SFN | System Frame Number |
| MAC | Medium Access Control | S-GW | Serving Gateway |
| MIB | Master Information Block | SI | System Information |
| NAS | Non-Access Stratum | SIB | System Information Block |
| NG-RAN | NG Radio Access Network | SpCell | Special Cell |
| NR | NR Radio Access | SRB | Signalling Radio Bearer |
| PBR | Prioritised Bit Rate | SRS | Sounding Reference Signal |
| PCell | Primary Cell | SS | Search Space |
| PCI | Physical Cell Identifier | SSB | SS/PBCH block |
| PDCCH | Physical Downlink Control Channel | | |
| SSS | Secondary Synchronisation Signal | | |
| PDCP | Packet Data Convergence Protocol | SUL | Supplementary Uplink |
| PDSCH | Physical Downlink Shared Channel | | |
| TM | Transparent Mode | | |
| PDU | Protocol Data Unit | UCI | Uplink Control Information |
| PHR | Power Headroom Report | UE | User Equipment |
| PLMN | Public Land Mobile Network | UM | Unacknowledged Mode |
| PRACH | Physical Random Access Channel | | |
| CRP | Cell Reselection Priority | | |
| PRB | Physical Resource Block | PSS | Primary Synchronisation Signal |
| PUCCH | Physical Uplink Control Channel | | |
| PUSCH | Physical Uplink Shared Channel | | |

1. A method performed by a terminal, the method comprising:
receiving, from a base station, a radio resource control (RRC) message, wherein the RRC message comprises:
a parameter for a configured grant reference signal received power (RSRP) threshold for a configured grant for RACH-less handover; and
a parameter for a bitmap related to a synchronization signal/physical broadcast channel block (SSB) subset for the configured grant for RACH-less handover; and
performing a first uplink transmission for RACH-less handover based on the configured grant for RACH-less handover,
wherein, before performing the first uplink transmission for RACH-less handover, the terminal:
determines that Synchronization Signal (SS)-RSRP of at least one SSB corresponding to the configured grant for RACH-less handover is above the configured grant RSRP threshold;
selects, from among SSBs associated with the configured grant, an SSB having an SS-RSRP above the configured grant RSRP threshold; and
considers the configured grant for RACH-less handover to be valid, and
wherein:
the configured grant for RACH-less handover is released in case that an uplink grant for a new transmission on a specific Hybrid Automatic Retransmission Request (HARQ) process is received; and
the specific HARQ process is a HARQ process used for the first uplink transmission.

2-3. (canceled)

4. The method of claim 1,
wherein the terminal determines the SSB associated with the configured grant for RACH-less handover based on the parameter for the bitmap.

5. The method of claim 4, wherein:
a first bit of the bitmap corresponds to SSB index 0; and
a second bit of the bitmap corresponds to SSB index 1.

6. The method of claim 5, wherein:
a value of 0 in the bitmap indicates that corresponding SSB is not used for SSB-to-physical uplink shared channel (PUSCH) mapping; and
a value of 1 in the bitmap indicates that corresponding SSB is used for SSB-to-PUSCH mapping.

7. The method of claim 5, wherein:
an SSB index of an SSB is determined based on a specific reference signal;
the specific reference signal is located on specific symbols of the SSB; and
the specific symbols are the first symbol, the second symbol and the third symbol.

8. (canceled)

9. A method performed by a terminal, the method comprising:
receiving, from a base station, a radio resource control (RRC) message, wherein the RRC message comprises a parameter for a bitmap related to a synchronization signal/physical broadcast channel block (SSB) subset for a configured grant for RACH-less handover; and
performing a first uplink transmission for RACH-less handover based on the configured grant for RACH-less handover,
wherein, after performing the first uplink transmission for RACH-less handover and before receiving an uplink grant for a new transmission on a specific hybrid automatic repeat request (HARQ) process, the terminal:
determines that an SSB corresponding to the configured grant has the same SSB index as an SSB selected for the first uplink transmission for RACH-less handover; and
considers the configured grant for RACH-less handover to be valid,
wherein the configured grant for RACH-less handover is released upon receiving the uplink grant for the new transmission on the specific HARQ process, and wherein the specific HARQ process is a HARQ process used for the first uplink transmission.
